(19) United States
(12) Patent Application Publication
(10) Pub. No.: US 2024/0037160 A1
(43) Pub. Date: Feb. 1, 2024

(54) Token System With Means of Contact

(71) Applicant: Jay Hall, Scottsdale, AZ (US)

(72) Inventor: Jay Hall, Scottsdale, AZ (US)

(21) Appl. No.: 17/873,259

(22) Filed: Jul. 26, 2022

(51) Int. Cl. G06F 16/9535; G06F 16/955; A63F 1/06; G06Q 50/00

(52) U.S. Cl. CPC G06F 16/9535; G06F 16/955; A63F 1/06; G06Q 50/01

(57) ABSTRACT

The disclosure is the only product of its kind that elevates the old passing of a paper note to a high-tech option that employs messaging technology to provide users with the convenience of chatting directly via on-line dating/meet-up sites that are disconnected from one's personal contact information, but with people they already have come across in person. This unprecedented device is uniquely designed to offer users with a new and improved means of connecting with others via poker chip that works in complement with a state of the art interactive website providing an alternative means to engage with new prospects, whether for social, personal or business needs.

### BACKGROUND

In many situations, there is a lack of privacy to converse or the conversation gets interrupted prematurely with no means to foster a connection, later. The awkward exchange of personal information also often gets lost, misheard or the person does not feel comfortable asking the other for contact information after only a short exchange of non-verbal possible interest. These situations are typical of a missed connection, where people are unable to establish a means of further communication after meeting and/or noticing another. There have been no products available as original equipment or as an aftermarket to address this problem.

An apparatus to simplify communicating at a later date someone, you don't know that you have met is not being met by any known device or system at present. There have been no products available as original equipment or as an aftermarket to address this problem either.

### SUMMARY OF THE INVENTION

The main purpose of the Token System with Means of Contact is to provide users with a poker chip labeled with a stock greeting on one side and a unique numeric code on the other, which can be passed to a person of interest, greeting side up, to allow for further communication and connection.

A disclosed token system comprising a token comprising an identification side having a contact data and an information side having an access code to the contact data. The disclosure also includes an internet page comprising an address identified by the contact data and configured to allow access to a personal data stored via the access code.

### BRIEF DESCRIPTION OF THE DRAWINGS

FIG. 1 is a front elevational view of the token system with a poker chip like means of contact in accordance with an embodiment of the present disclosure.

FIG. 2 is a back elevational view of the token system poker chip like means of contact in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

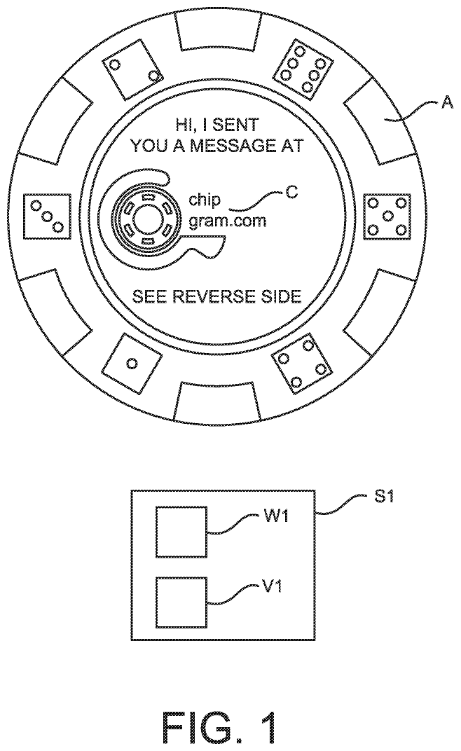

FIG. 1 is a front elevational view of the token system poker chip like means of contact showing: chipgram; a physical 11 gram poker chip with a greeting on one side referenced as A, and contact data C such as a web site address or phone number in accordance with an embodiment of the present disclosure. The depicted token has the shape and size and appearance of a poker chip but also takes the form of a credit card, a triangle, a square and other geometric shapes and flat stock patterns. The server S1 and the webpage or internet page W1 resides electronically on the server. A virtual token V1 also resides on the server S1 or on multiple servers. An owner of the token is a person or an entity and a recipient is a person and an electronic entity such as a bot and an electronic avatar.

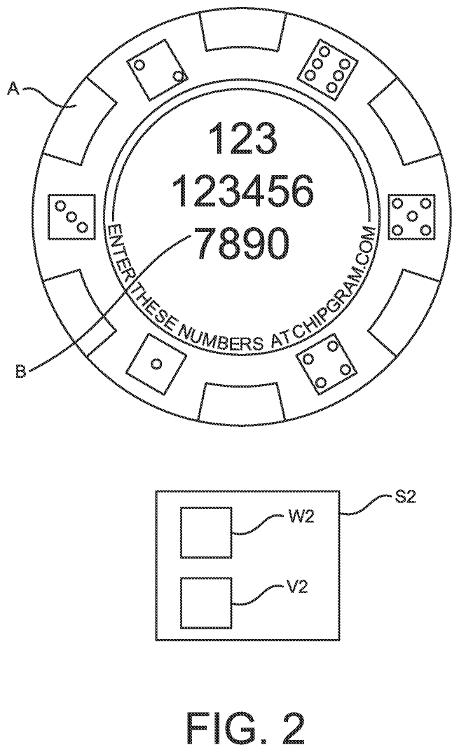

FIG. 2 is a back elevational view of the token system poker chip like means of contact in accordance with an embodiment of the present disclosure. The unique access code B enables a recipient of the token to access an owner's message or owner's personal data resident on a webpage or website as managed by the owner. Virtual tokens are also disclosed which are virtually given to the recipient via a social media page or a text or an electronic means. The server S2 and the webpage or internet page W2 resides electronically on the server. A virtual token V2 also electronically resides on the server S2 or on multiple servers. The owner of a virtual token may give the token to multiple people or leave the virtual token with at multiple locations for pickup.

The present disclosed Token with Means of Contact, also known as “Chipgram”, offers a modern data tool that can be delivered discreetly in seconds and it allows individuals access to someone's direct information, without an audience, to avoid the chances of a missed opportunity. Chipgram introduces a novel poker chip tool at eleven grams, which has a greeting on one side, and a unique code on the other. Chipgram allows users to pass the chip discreetly to a person of interest during a chance encounter without the awkward exchange. This avant-garde product follows the same concept of passing someone a paper note, except; to open and respond to the “note”, the recipient visits a website. That person logs in as a guest on the default page using the thirteen digit code found on the chip. The unique code will then connect the chip dealer also known as the member, and the chip recipient, exclusively with a chat window.

Unlike a paper note, however, the disclosure only requires the initial pass, whereas post first contact, both parties can correspond online at their leisure through a secure messaging system on a primary website without a physical presence. A variety of messages can be set ahead of time on the member's chips for common situations. These messages can be cleared for a custom message on each chip for a recipient if time allows and/or based on preference. Furthermore, the member can change the chip name from its color to either the actual name of the person, the venue, or even a word, to help them identify the conversation. This innovative, top-quality medium provides a simple means to allow individuals to connect and communicate without giving up personal contact information of either party, in immediate fashion and in a modern approach. The disclosure benefits all individuals who seek to have a convenient and simple method of connecting with people when going about their daily business or out having a good time.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A token system comprising:
a token comprising an identification side having a contact data and an information side having an access code to the contact data; and
an internet page comprising an address identified by the contact data and configured to allow access to a personal data stored via the access code.

2. The token system of claim 1, wherein the token is a plastic disc having a shape and size similar to a poker chip.

3. The token system of claim 1, wherein the identification side comprises an internet address.

4. The token system of claim 1, wherein the information side comprises a unique access code to an internet address on the identification side.

5. The token system of claim 1, wherein the contact data comprises an internet page address.

6. The token system of claim 1, wherein the contact data comprises a coded access to a text phone number.

7. The token system of claim 1, wherein the personal data comprises a message to a recipient of the physical token.

8. The token system of claim 1, wherein the token is virtual and electronically tagged via a name on a social media platform to a recipient identified by an owner of the token.

9. The token system of claim 1, wherein the token is virtual and electronically tagged via a phone number to a recipient identified by an owner of the token.

10. The token system of claim 1, wherein the personal data is stored via the internet page on the cloud.

11. The token system of claim 1, further comprising an identifier of a recipient of the token changeable by an owner of the token.

12. The token system of claim 1, further comprising a name identifier of a recipient of the token as set by an owner of the token via the internet page.

13. The token system of claim 1, further comprising a color identifier of a recipient chosen by an owner of the token.

14. The token system of claim 1, wherein the personal data is a message from an owner of the token to a specific recipient of the token.

15. The token system of claim 1, wherein a content of the internet page is managed by an owner of the token.

16. The token system of claim 1, wherein a content of the internet page allows an owner of the token to manage several tokens simultaneously.

17. The token system of claim 1, wherein the token contains no electronics nor identifying nor location tracking hardware.

18. The token system of claim 1, wherein the token is a plastic card having a shape and a size similar to a credit card.

19. The token system of claim 1, wherein the token is a plastic flat stock having a geometrical shape comprising a triangle, a square, a rectangle, a pentagon, a pentagram and an octogram.
